(19) United States
(12) Patent Application Publication
(10) Pub. No.: US 2007/0236133 A1
(43) Pub. Date: Oct. 11, 2007

(54) Field emission electrode, field emission device having the same and methods of fabricating the same

(75) Inventors: Eun-Ju Bae, Yongin-si (KR); Yo-Sep Min, Yongin-si (KR); Wan-Jun Park, Seoul (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/543,933

(22) Filed: Oct. 6, 2006

(30) Foreign Application Priority Data
Apr. 7, 2006 (KR) 10-2006-0031933

(51) Int. Cl. H01J 63/04; H01J 1/62

(52) U.S. Cl. 313/496

(57) ABSTRACT

Provided are a field emission electrode, a field emission device having the same and methods of fabricating the same. The field emission electrode may include a substrate, a ZnO layer formed on the substrate and a plurality of carbon nanotubes formed on the ZnO layer. A driving voltage of a field emission device may be reduced by applying an electrode that may include a plurality of single-walled carbon nanotubes formed on a ZnO layer to the field emission device.

### PRIORITY STATEMENT

This application claims priority under 35 USC § 119 to Korean Patent Application No. 10-2006-0031933, filed on Apr. 7, 2006, in the Korean Intellectual Property Office (KIPO), the entire contents of which are incorporated herein by reference.

### BACKGROUND

1. Field

Example embodiments relate to a field emission electrode, a field emission device having the same and methods of fabricating the same. Other example embodiments relate to a field emission electrode in which carbon nanotubes may be formed on a ZnO layer, a field emission device having the same and methods of fabricating the same.

2. Description of the Related Art

As display techniques develop, flat panel displays may be widely provided instead of conventional cathode ray tubes (CRTs). Liquid crystal display (LCD) devices and plasma display devices may be representative flat panel displays. Field emission displays that use carbon nanotubes have been developed. A field emission display is expected to be a next generation display because it has the advantages of CRT, e.g., relatively high brightness and a relatively wide viewing angle and may have the advantages of an LCD device, e.g., relatively lightweight and relatively slim.

The field emission display may emit light of a particular color from a phosphor material coated on an anode electrode when the phosphor material is excited by colliding with electrons emitted from a cathode electrode. The field emission display may be different from a CRT in that an electron emission source may be formed of a cold cathode material. Carbon nanotubes may be mainly used as an emitter, which is an electron emission source of the field emission display. Of the carbon nanotubes, single-walled carbon nanotubes, as an emitter of a field emission electrode, may emit electrons at a lower voltage due to its relatively small diameter compared to multi-walled carbon nanotubes.

A conventional field emission electrode that uses carbon nanotubes may be fabricated by coating a conductive paste on a substrate after mixing the conductive paste with carbon nanotubes. An organic material mixed with the conductive paste may be outgassed in a subsequent process, thereby reducing the lifetime of a device. Also, when a plasma chemical vapor deposition method is used for growing carbon nanotubes directly on a substrate, single-walled carbon nanotubes may not be formed and multi-walled carbon nanotubes may be grown.

### SUMMARY

Example embodiments provide a field emission electrode in which carbon nanotubes may be grown on a relatively chemically stable electrode at a relatively high temperature and a field emission device having the same. Example embodiments also provide methods of fabricating the field emission electrode and the field emission device.

According to example embodiments, a field emission electrode may include a substrate, a ZnO layer formed on the substrate, and a plurality of carbon nanotubes formed on the ZnO layer. The plurality of carbon nanotubes may be a plurality of single-walled carbon nanotubes. The ZnO layer may have a specific resistance of about 1×10⁻⁵˜10 Ωcm.

According to example embodiments, a field emission device including the field emission electrode of example embodiments may further include the ZnO layer in a stripe shape on the substrate acting as cathode electrodes, an insulating layer with gate holes that expose the cathode electrodes, a gate electrode with gate electrode holes in communication with the gate holes on the insulating layer and an anode electrode and phosphor layers on an inner surface of another substrate.

According to other example embodiments, a method of fabricating a field emission electrode may include forming a ZnO layer on a substrate, forming a catalyst on the ZnO layer and forming a plurality of carbon nanotubes on the ZnO layer. The ZnO layer may be formed using one of a CVD method, a sputtering method and/or an atomic layer deposition method. The ZnO layer may be formed at a temperature of about 100° C. to about 500° C. and a pressure of about 5 Torr or less using diethylzinc and water by an atomic layer deposition method.

According to example embodiments, a method of fabricating a field emission device including the field emission electrode fabricated according to example embodiments may further include forming the ZnO layer in a stripe shape on the substrate to act as cathode electrodes, forming an insulating layer with gate holes that expose the cathode electrodes, forming a gate electrode with gate electrode holes in communication with the gate holes on the insulating layer and forming an anode electrode and phosphor layers on an inner surface of another substrate.

### BRIEF DESCRIPTION OF THE DRAWINGS

Example embodiments will be more clearly understood from the following detailed description taken in conjunction with the accompanying drawings. FIGS. 1-6 represent non-limiting, example embodiments as described herein.

FIG. 1 is a diagram illustrating a structure of a field emission electrode according to example embodiments;

FIG. 2 is a diagram illustrating a field emission display that uses a field emission electrode according to example embodiments;

FIGS. 3A-3C are diagrams illustrating a method of fabricating a field emission electrode according to example embodiments;

FIG. 4 is a transmission electron microscopy (TEM) image of single-walled carbon nanotubes formed on a ZnO layer according to example embodiments;

FIG. 5 is a graph showing a field emission characteristic of a field emission electrode according to example embodiments; and

FIG. 6 is a photograph showing green light emission from a field emission electrode according to example embodiments.

### DETAILED DESCRIPTION OF EXAMPLE EMBODIMENTS

Example embodiments are described more fully hereinafter with reference to the accompanying drawings, in which example embodiments are shown. Example embodiments may, however, be embodied in many different forms and should not be construed as limited to the embodiments set forth herein. Rather, these embodiments are provided so that this disclosure will be thorough and complete and will fully convey the scope of example embodiments to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

Spatially relative terms, such as “beneath,” “below.” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements and/or components, but do not preclude the presence or addition of one or more other features, integers, steps, operations, elements, components and/or groups thereof.

Example embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

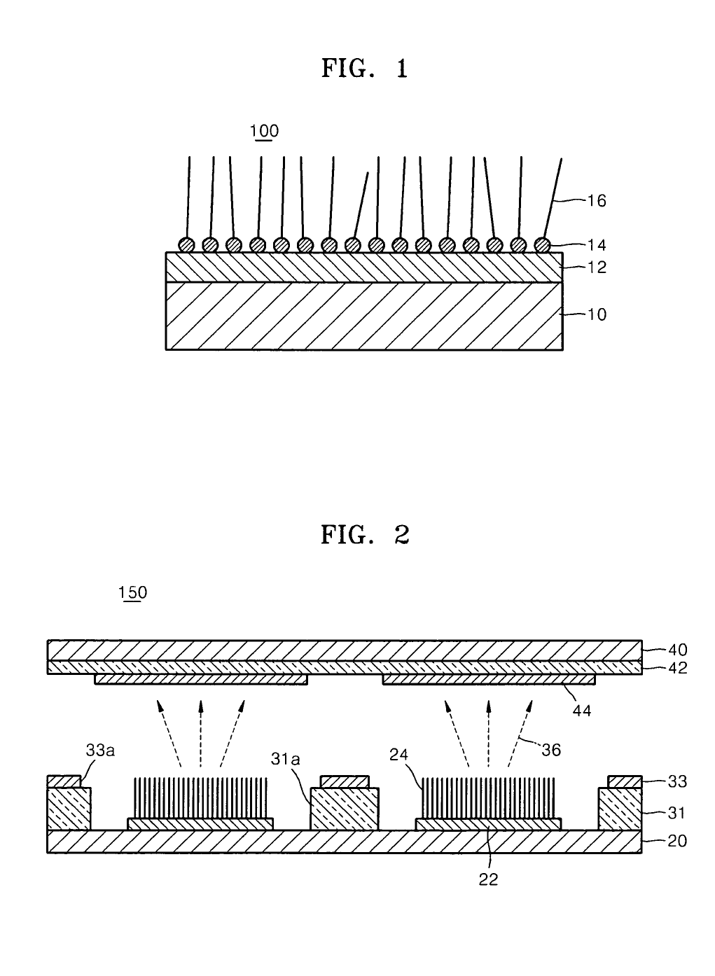

FIG. 1 is a diagram illustrating a structure of a field emission electrode 100 according to example embodiments. Referring to FIG. 1, the field emission electrode 100 may include a substrate 10, a ZnO layer 12 formed on the substrate 10 and carbon nanotubes 16 formed on the ZnO layer 12. The carbon nanotubes 16 may be grown on a catalyst material 14. The substrate 10 may be a glass substrate and/or a semiconductor substrate. The ZnO layer 12 formed on the substrate 10 may be an electrode layer. A ZnO mono crystal may be an insulator at room temperature and may have a specific resistance of about 10² Ωcm due to point defects (e.g., oxygen, interstitial Zn and/or hydrogen defect).

When a thin film is formed using ZnO, the thin film ZnO may have a specific resistance range of about 1×10⁻⁵˜10⁸ Ωcm. The thin film ZnO may be formed as an insulator, a semiconductor and/or a conductor according to a method of forming and process conditions. The ZnO layer 12 used in example embodiments may serve as an electrode. The ZnO layer 12 may have a specific resistance range of about 1×10⁻⁵˜10 Ωcm, for example, about 1×10⁻⁴˜1×10⁻² Ωcm. The specific resistance of the ZnO thin film may be controlled through the fabrication process of the ZnO thin film. When the ZnO thin film is fabricated using an atomic layer deposition method, the specific resistance may be controlled to a desired range, but the method of controlling the specific resistance of the ZnO thin film is not limited to the atomic layer decomposition method. The ZnO layer 12 may have a relatively large band gap and be relatively chemically stable. The conductivity of the ZnO layer 12 may be controlled by doping a dopant (e.g., In, Al, Li, Tb, Ga, Co, B and/or Zr).

The ZnO layer 12 may be stable at a relatively high temperature, thus the carbon nanotubes may be stably formed on the substrate 10 at a relatively high temperature. The ZnO layer 12 may have a thickness of about 10 Å to about 10000 Å. If the thickness of the ZnO layer 12 is about 10 Å or less, a uniform thickness of the thin film may not be ensured, and if it is about 10000 Å or more, the size of the device may increase, thereby increasing fabricating costs. The carbon nanotubes 16 formed on the ZnO layer 12 may be multi-walled carbon nanotubes, single-walled carbon nanotubes and/or a mixture of multi-walled and single-walled carbon nanotubes. The carbon nanotubes 16 may be single-walled carbon nanotubes. A field emission electrode according to example embodiments may be used in a field emission device (e.g., a field emission display and/or a field emission backlight).

FIG. 2 is a diagram illustrating a field emission display 150 that uses a field emission electrode according to example embodiments. Referring to FIG. 2, the field emission display 150 may include first and second substrates 20 and 40 spaced a predetermined or given distance from each other. Cathode electrodes 22 may be formed in a stripe shape on the first substrate 20. Carbon nanotubes 24 may be formed on the cathode electrodes. An insulating layer 31 with gate holes 31a that expose the cathode electrodes 22 and a gate electrode 33 with gate electrode holes 33a in communication with the gate holes 31a may be formed on the insulating layer 31, which may be formed on the first substrate 20.

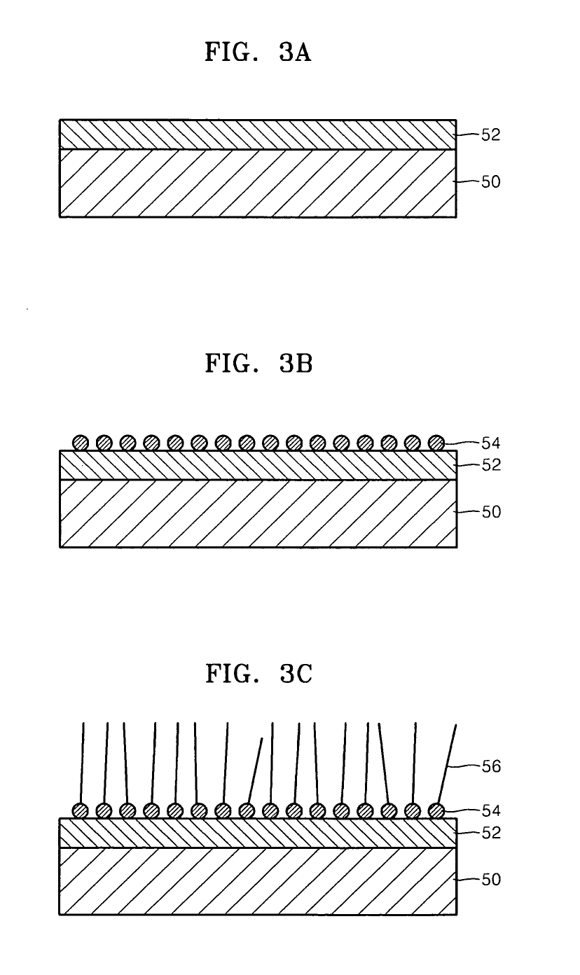

An anode electrode 42 and phosphor layers 44 may be sequentially formed on an inner surface of the second substrate 40. The cathode electrodes 22 may be formed of ZnO layers. When a negative voltage is applied to the gate electrode 33 and the cathode electrodes 22, electrons 36 may be emitted from the cathode electrodes 22. The electrons 36 may move toward the anode electrode 42 to which a positive voltage is applied and may excite the phosphor layer 44 to emit light. Hereinafter, a method of fabricating a field emission electrode will now be described through example embodiments, but example embodiments may not be limited to the following example embodiments. FIGS. 3A-3C are diagrams illustrating a method of fabricating a field emission electrode according to example embodiments. Referring to FIG. 3A, a ZnO layer 52, which is a conductive thin film having a thickness of about 50 nm, may be formed on a silicon substrate 50. The ZnO layer 52 may be formed using a chemical vapor deposition (CVD) method, a sputtering method and/or an atomic layer deposition method.

In the atomic layer deposition method, the ZnO layer 52 may be deposited at a temperature of about 100° C.-about 500° C. under a pressure of about 5 Torr using diethylzinc and water, respectively, as Zn and oxygen sources. The ZnO layer 52 may be deposited at a temperature of about 250° C. under a pressure of about 0.6 Torr. The ZnO layer 52 may have a specific resistance of about 3.8×10⁻³ Ωcm when the specific resistance is measured using a four-point probe, and may have an electron mobility and a carrier concentration of about 19.5 cm²/Vsec and about 7.4×10¹⁹/cm³, respectively.

The ZnO layer fabrication process may be a process of fabricating a doped ZnO layer with a dopant. A doped ZnO layer may be formed using a ZnO source doped in advance with a dopant and/or adding a source including a dopant in a ZnO source by a CVD method, a reactive deposition method, a spray thermal decomposition method, a sol-gel method, a sputtering method and/or a molecular beam deposition method. The dopant may be In, Al, Li, Tb, Ga, Co, B and/or Zr. For example, a ZnO:Al layer may be deposited by an RF magnetron sputtering method using a ZnO disc doped with Al₂O₃ as a target, and a ZnO:Ga layer may be deposited by a plasma chemical vapor deposition method using diethylzinc and trimethyl gallium. The ZnO layer 52 may be patterned for selectively forming carbon nanotubes for fabricating a field emission display device. The ZnO layer 52 may be readily patterned by etching with a methane gas and/or an HCl gas using a silicon oxide film (SiO₂) and/or a metal as a mask.

FIG. 3B is a diagram of a process of forming a catalyst material 54 on the ZnO layer 52. The catalyst material 54 may be formed on the ZnO layer 52 using an electron beam deposition method, a CVD method, a sputtering method and/or a spin coating method. The catalyst material 54 may be formed by coating an aqueous solution that contains catalyst metal particles on the ZnO layer 52. The catalyst metal may be Ni, Fe, Co and/or an alloy of these metals. For example, the catalyst material 54 may be formed by heating the silicon substrate 50 at a temperature of about 100° C. for about 2 minutes after an aqueous solution that contains Fe is coated on the ZnO layer 52 on the silicon substrate 50 using a spin coating method. The aqueous solution may be made by adding iron nitride, bis(acetylacetonate)dioxomolybdenum and alumina nano particles to polyvinylpyrolydon (PVP) and water.

Referring to FIG. 3C, carbon nanotubes 56 may be formed on the catalyst material 54. The carbon nanotubes 56 may be grown using a CVD method. The carbon nanotubes 56 formed on the ZnO layer 52 may be multi-walled carbon nanotubes, single-walled carbon nanotubes and/or a mixture of the multi-walled carbon nanotubes and the single-walled carbon nanotubes. To form single-walled carbon nanotubes, a water plasma CVD method may be used. Water may activate the catalyst and may provide energy for growing the carbon nanotubes 56 at a relatively low temperature.

In example embodiments, single-walled carbon nanotubes may be formed at a temperature in a range of about 300° C. to about 600° C. and a pressure of about 1 Torr or less using methane gas and water by a water plasma CVD method. Single-walled carbon nanotubes may be formed by injecting methane gas at a flowrate of about 60 sccm with water into a chamber (not shown) which is maintained at a plasma power of about 15 W, pressure of about 0.37 Torr and temperature of about 450° C.

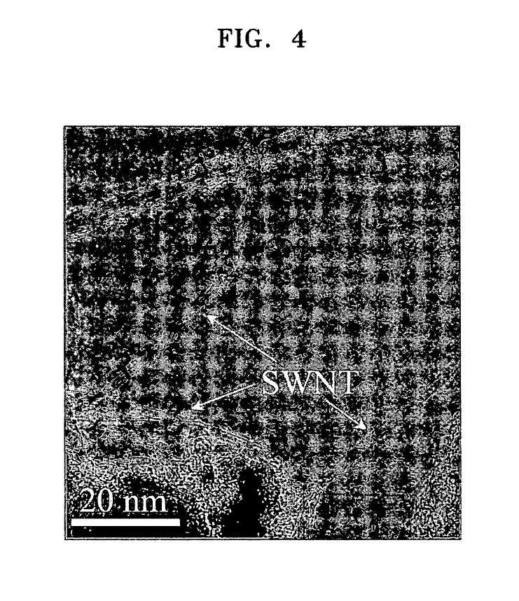

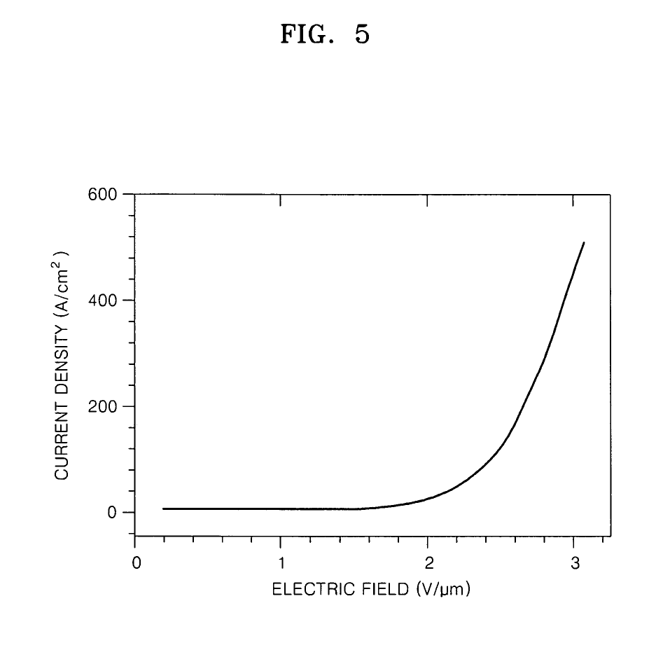

FIG. 4 is a TEM image of single-walled carbon nanotubes formed on a ZnO layer according to example embodiments. The carbon nanotubes formed on the ZnO layer may be observed to be single-walled carbon nanotubes. FIG. 5 is a graph showing a field emission characteristic of a field emission electrode according to example embodiments. Referring to FIG. 5, emission current may increase at an applied voltage of about 1.8 V/μm. A field emission device that uses the single-walled carbon nanotubes may be operated at a relatively low voltage.

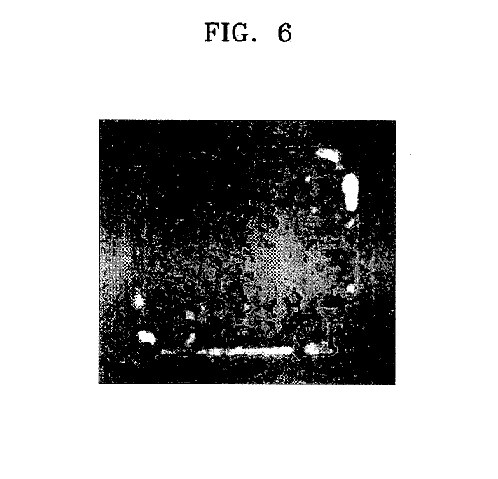

FIG. 6 is a photograph showing green light emission from a field emission electrode according to example embodiments. As described above, according to example embodiments, single-walled carbon nanotubes may be readily formed on a ZnO layer which is a chemically stable electrode at a relatively high temperature. A driving voltage of a field emission device may be reduced by applying an electrode, which may include single-walled carbon nanotubes formed on a ZnO layer, to the field emission device.

While example embodiments have been particularly shown and described with reference to example embodiments thereof, it will be understood by those of ordinary skill in the art that various changes in form and details may be made therein without departing from the spirit and scope of the following claims.

What is claimed is:

1. A field emission electrode comprising:
a substrate;
a ZnO layer formed on the substrate; and
a plurality of carbon nanotubes formed on the ZnO layer.

2. The field emission electrode of claim 1, wherein the plurality of carbon nanotubes are a plurality of single-walled carbon nanotubes.

3. The field emission electrode of claim 1, wherein the ZnO layer includes at least one material selected from the group consisting of In, Al, Li, Tb, Ga, Co, B and Zr.

4. The field emission electrode of claim 3, wherein the ZnO layer has a specific resistance of 1×10⁻⁵˜10 Ωcm.

5. The field emission electrode of claim 1, wherein the ZnO layer has a thickness of about 10 Å to about 10000 Å.

6. The field emission electrode of claim 1, wherein the substrate is a glass substrate or a semiconductor substrate.

7. A method of fabricating a field emission electrode comprising:
forming a ZnO layer on a substrate;
forming a catalyst on the ZnO layer; and
forming a plurality of carbon nanotubes on the ZnO layer.

8. The method of claim 7, wherein forming the ZnO layer includes forming the ZnO layer including at least one material selected from the group consisting of In, Al, Li, Tb, Ga, Co, B and Zr.

9. The method of claim 7, wherein forming the ZnO layer includes forming the ZnO layer having a specific resistance of about 1×10⁻⁵˜10 Ωcm.

10. The method of claim 7, wherein forming the ZnO layer includes forming the ZnO layer using one method selected from the group consisting of a CVD method, a sputtering method, and an atomic layer deposition method.

11. The method of claim 10, wherein forming the ZnO layer includes forming the ZnO layer at a temperature of about 100° C. to about 500° C. and pressure of about 5 Torr or less using diethylzinc and water as raw materials using an atomic layer deposition method.

12. The method of claim 7, wherein forming the catalyst includes using one method selected from the group consisting of an electron beam deposition method, a CVD method, a sputtering method and an aqueous coating method.

13. The method of claim 7, wherein forming the catalyst includes coating an aqueous solution that contains a catalyst material on the ZnO layer.

14. The method of claim 13, wherein forming the catalyst material includes forming at least one selected from the group consisting of Ni, Fe, and Co.

15. The method of claim 7, wherein forming the plurality of carbon nanotubes includes forming the carbon nanotubes using a CVD method.

16. The method of claim 7, wherein forming the plurality of carbon nanotubes includes forming a plurality of single-walled carbon nanotubes.

17. The method of claim 16, wherein forming the plurality of single-walled carbon nanotubes includes a water plasma CVD method.

18. The method of claim 17, wherein forming the plurality of single-walled carbon nanotubes is performed at a temperature of about 300° C. to about 600° C. under a pressure of about 1 Torr or less using methane gas and water.

19. A field emission device including the field emission electrode of claim

20. The field emission device of claim 19, wherein
the ZnO layer is in a stripe shape on the substrate and acts as cathode electrodes, the field emission device further comprising:
an insulating layer with gate holes that expose the cathode electrodes;
a gate electrode with gate electrode holes in communication with to the gate holes on the insulating layer; and
an anode electrode and phosphor layers on an inner surface of another substrate.

21. A method of fabricating a field emission device including fabricating the field emission electrode according to claim 7.

22. The method of claim 21, wherein
the ZnO layer is formed in a stripe shape on the substrate to act as cathode electrodes; the method further comprising:
forming an insulating layer with gate holes that expose the cathode electrodes;
forming a gate electrode with gate electrode holes in communication with the gate holes on the insulating layer; and
forming an anode electrode and phosphor layers on an inner surface of another substrate.
